(19) United States
(12) Patent Application Publication
(10) Pub. No.: US 2019/0055122 A1
(43) Pub. Date: Feb. 21, 2019

(54) Torrefaction Of Biomass Feed With Steam Stripping

(71) Applicant: Syngas Technology, LLC, Elk River, MN (US)

(72) Inventors: Duane A. Goetsch, Andover, MN (US); Jeffery Potter, Big Lake, MN (US)

(21) Appl. No.: 15/678,333

(22) Filed: Aug. 16, 2017

(51) Int. Cl. C01B 3/32; B01J 8/24

(52) U.S. Cl. CPC C01B 3/32; B01J 8/24; C01B 2203/1258; C01B 2203/1211; C01B 2203/0805

(57) ABSTRACT

A process for optimizing a biomass feedstock for gasification for the production of syngas. The biomass feed, which is preferably a lignocellulosic material, is subjected to controlled torrefaction followed by steam stripping of the torrefied solids. The biomass undergoes a weight loss of about 10% to 15% on a dry ash free basis. This increases the energy density and friability of the stripped torrefied biomass and results in higher efficiency on subsequent densification or gasification.

### FIELD OF THE INVENTION

The present invention relates to a process for optimizing a biomass feedstock for gasification for the production of syngas. The biomass feed, which is preferably a lignocellulosic material, is subjected to controlled torrefaction followed by steam stripping of the torrefied solids. The biomass undergoes a weight loss of about 10% to 15% on a dry ash free basis. This increases the energy density and friability of the stripped torrefied biomass and results in higher efficiency on subsequent densification or gasification.

### BACKGROUND OF THE INVENTION

A substantial amount of research and development is being done to reduce our dependency on petroleum-based energy and to move us toward more sustainable energy sources, such as wind energy, solar energy, and biomass. Of these three sustainable energy sources, biomass has received significant attention. One reason for this is because biomass is widely available in many forms. Also, the economy of agricultural regions that are growing crops can greatly benefit from biomass to transportation fuel plants. Thus, governmental bodies in agricultural regions are very supportive of proposed biomass plants. In order to convert biomass to high value products, such as transportation fuels, one promising process is to first convert the biomass to syngas by gasification. Gasification is a well-known process for producing synthesis gas (syngas), which is a gas mixture containing varying amounts of carbon monoxide and hydrogen as the major components.

Various types of gasifier designs are known. The most common type of gasifier used in biomass gasification is believed to be an up-draft fixed-bed design (counter-current) design, in which air, oxygen and/or steam flows upward through a permeable bed of biomass and counter-currently to the flow of ash and other byproducts of the reaction. Typical up-draft gasifiers have significant technical shortcomings. First, the introduction of air into the hot gasification chamber partly combusts the biomass, resulting in a lower overall heating value compared to gasifiers that employ indirect heating. Second, if air is used as the gasification agent, nitrogen in the air which is a diluent, reduces the energy content per unit volume of output gas, making the output gas less useful for such things as gas turbines, for storage, and for subsequent chemical processing. Third, tars and phenolic hydrocarbons produced in an up-draft gasifier require removal to reduce emissions, avoid fouling of a gas turbine, and avoid catalyst poisoning when used to create liquid fuels. The removal equipment adds to system complexity and size, with the result that for economic reasons the gasifier is usually limited only to large installations. Because biomass is a low-energy content fuel and is dispersed geographically, a large-scale gasifier requires transport and storage of the biomass, which negatively affects the economic payback for the system.

A more advantageous type of gasifier for biomass is a fluidized bed gasifier whereby a volume of gas, such as steam and air and/or oxygen is passed through a bed of biomass with sufficient velocity to create a fluidized-bed of biomass particles. This mode of operation is advantageous to up-draft fixed bed gasifiers in that the fluidized bed allows for a more uniform temperature distribution within the gasifier and thus can result in a higher syngas yield and a reduction in unwanted by-products, such as tar and soot. This type of gasifier suffers from a requirement that the particles of biomass must be reduced in size by several orders of magnitude that can consume a significant amount of energy—in some cases up to 30% of the energy contained in the biomass itself.

In view of the above, there is a need for biomass gasification processes and equipment that are economically practical for use at medium- to small-scale installations, including direct sources of biomass such as agricultural operations (for example, farms), factories in which biomass materials are starting materials and/or byproducts (for example, paper mills, ethanol plants, etc.), bioplants, and small towns or villages. There is also a need for biomass pretreatment processes that result in a more efficient and economical feed for gasification. One such pretreatment is torrefaction. Torrefaction is a relatively mild pretreatment of biomass at a temperature from about 200° C. to about 350° C. The properties of the biomass are changed to increase its heating value, reduce its tendency to degrade during storage, and make it more friable and hence easier to mill. Conventional torrefaction processes are used to produce a densified product that can be used in place of or in conjunction with coal.

While both torrefaction and gasification of biomass are well known, there is still a need in the art for improved processes combining these two technologies that can lead to a more efficient and economical process for converting biomass to transportation fuels.

### SUMMARY OF THE INVENTION

In accordance with the present invention there is provided a process for preparing a biomass feedstream for gasification, which process comprises:

a) comminuting said biomass to an effective particle size;

b) conducting said comminuted biomass to a drying zone wherein at least about 90 wt. % of water is removed thereby resulting in a dried comminuted biomass stream and a first vapor stream;

c) passing said dried comminuted biomass stream to a torrefaction zone where it is torrefied at temperatures ranging from about 200° C. to about 350° C., in a substantially non-oxidizing environment and at an effective residence time to result in a weight loss of from about 10% to about 15% on a dry ash-free basis, thereby resulting in a second vapor phase stream comprised of water vapor and small amounts of organic components, and a torrefied comminuted biomass solids stream containing small amounts of organic moieties;

d) passing said torrefied comminuted biomass solids stream to a stream stripping zone wherein it is contacted with superheated steam wherein at least a portion of said organic moieties is stripped from the torrefied comminuted biomass solids;

e) passing at least a portion of said stripped torrefied dried comminuted biomass stream to a gasification zone;

f) venting at least a portion of said first vapor stream to the atmosphere and conducting at least a portion of any remaining first vapor stream to a combustion zone;

g) conducting at least a portion of said second vapor stream to said combustion zone and recycling at least a portion of any remaining second vapor stream to said torrefaction zone to act as a sweep gas, wherein said combustion zone is operated at an effective time and temperature that will result in the conversion of at least 99 wt. % of any volatile organic components from said second vapor phase to a hot flue gas;

h) conducting a portion of said hot flue gas to said drying zone to provide at least a portion of the heat necessary to dry the biomass to a predetermined level;

i) passing at least a portion of the remaining hot flue gas through a first passageway of a heat exchanger having a first passageway and a second passageway contiguous to each other but not in fluid communication with each other, wherein each of said passageways having an inlet and an outlet and wherein each passageway is constructed to allow a fluid to pass from its inlet to its outlet and to allow heat to be transferred from a fluid of one passageway to a fluid in the other passageway; and

j) passing a heat transfer medium through said second passageway of said heat exchanger wherein heat is transferred from said hot flue gas passing through said first passageway of said heat exchanger thereby resulting in a heated heat transfer medium and a cooled flue gas.

### BRIEF DESCRIPTION OF THE FIGURE

FIG. 1 hereof is a simplified flow diagram of one preferred embodiment for practicing the present invention.

### DETAILED DESCRIPTION OF THE INVENTION

Any biomass feedstock can be used in the practice of the present invention. Preferred are plant biomass feedstocks, typically referred to as lignocellulosic feedstocks, which are generally comprised of cellulose, hemicellulose, and lignin. Non-limiting examples of plant, or lignocellulosic, feedstocks include non-woody plant biomass, cultivated crops, such as, but not limited to, grasses, for example, but not limited to, C4 grasses, such as switchgrass, cord grass, rye grass, miscanthus, reed canary grass, or a combination thereof, or sugar processing residues such as bagasse, or beet pulp, agricultural residues, for example, soybean stover, corn stover, rice straw, rice hulls, barley straw, corn cobs, wheat straw, canola straw, rice straw, oat straw, oat hulls, corn fiber, recycled wood pulp fiber, sawdust, hardwood, for example aspen wood and sawdust, softwood, or a combination thereof. Further, the lignocellulosic feedstock may include cellulosic waste material such as, but not limited to, newsprint, cardboard, sawdust, and the like. For urban areas, the best potential plant biomass feedstock includes yard waste (e.g., grass clippings, leaves, tree clippings, and brush) and vegetable processing waste.

Lignocellulosic feedstock can include one species of fiber or alternatively, lignocellulosic feedstock can include a mixture of fibers that originate from different lignocellulosic feedstocks. Furthermore, the lignocellulosic feedstock can comprise fresh lignocellulosic feedstock, partially dried lignocellulosic feedstock, fully dried lignocellulosic feedstock or a combination thereof. In general, the term “biomass” as used herein includes all of the terms, plant biomass, lignocellulosic, cellulosic, and hemicellulosic. It is preferred that the biomass used in the practice of the present invention comprised at least about 30 wt. % cellulose/hemicelluloses, based on the total weight of the biomass.

The biomass is preferably dried, then reduced to an effective size before the torrefaction pretreatment step. Technologies for drying biomass are well known in the art and include both passive, as well as active drying. Passive drying is preferred for cost considerations, but depending on the nature of the biomass, passive drying may not be able to reduce the moisture level to a level acceptable for being fed to a gasifier. Therefore, some form of active drying, such as the use of an external heat source and blowers may be needed.

It is preferred that the biomass, after drying, contains no more than about 2.0 wt. %, preferably no more that about 1.5 wt. %, and more preferably no more than about 1.0 wt. % water, based on the total weight of the biomass after drying. The biomass is subjected to a size reduction step to reduce it to a size suitable for drying and torrefaction. It is preferred that the size reduction step result in a biomass feed having an average particle size of about 0.1 inch to about 3 inches, preferably from about 0.25 inches to 1.5 inches. If any of the biomass is to be sent directly to a gasifier than it is preferred that the average particle size of that portion should be from about 1 to 500 microns, preferably from about 150 microns to 300 microns. The fibrous structure of the biomass makes it very difficult and costly to reduce its particle size. Non-limiting examples of mechanical size reduction equipment include rotary breakers, roll crushers, jet mills, cryogenic mills, hammer mills, impactors, tumbling mills, roller mills, shear grinders, and knife mills. Hammer mills are preferred for the practice of the present invention.

The biomass is subjected to torrefaction after size reduction and drying which results in an increase in its carbon content, a reduction in oxygen content, and the substantial elimination of storage hygroscopicity and degradation. Torrefaction is a process of exposing biomass to heat in the absence of air or oxygen between about 200 to about 350° C., preferably from about 225° C. to about 320° C., more preferably about 260° C. to about 300° C. While torrefaction results in the removal of a substantial fraction of volatile species, as well as a fraction of the oxygen, enough of the volatiles remain in the torrefied solids to pose a potential safety issue downstream, especially when pelleted and packaged. Further the torrefied biomass results in a more friable material with increased energy density that tends to be hydrophobic and less prone to rotting. The products of torrefaction are a solid char material, water vapor, and a number of organic species including carbon dioxide, carbon monoxide, acetic acid, formaldehyde, acetaldehyde, as well as a number of other compounds in lower concentration. Torrefaction has been proposed as a means to make biomass more closely resemble coal and as a means to make the transport and storage of biomass more viable due to the increased density and greater storage stability. There has been some work that has examined if torrefaction should be used as a preprocessing step for gasification. It is conventional wisdom that the loss in overall energy in the biomass from torrefaction nullifies any potential benefit that torrefaction would have on the gasification process (typically the weight loss from torrefaction outweighs the energy density gain).

This prior art ignores several critical points. First, gasification experiments were typically done at extremely high temperature (1200 to 1300° C.) which is outside the range of temperature where biomass is typically gasified. At such high temperature conditions, even very stable tars or methane will react and thermodynamic equilibrium will favor the production of CO over CO₂. In addition, the water gas shift reaction is fairly facile at these conditions so any CO₂ produced directly via any direct decomposition route would rapidly equilibrate to the levels predicted by equilibrium. Biomass gasification is typically practiced at much lower temperatures (650 to 950° C.) where tar and methane are much more stable and CO₂ is more thermodynamically favorable than at high temperature. In addition, while it is true that torrefaction does result in less mass fed to the gasifier and hence potentially lower yields to carbon monoxide, this is only true if the additional mass would have been converted to product and not byproducts. Similarly, while it is true that the weight loss from torrefaction is typically greater than the energy density gain from torrefaction, the real metric to examine is the yield to carbon monoxide vs. weight loss from torrefaction as the yield to product is not constant across all degrees of torrefaction.

The inventors hereof have found that torrefaction can have a significant benefit on gasification by recognizing three important factors that have been overlooked in prior work coupling the benefits of torrefaction with gasification:
a) Prior art has only examined the thermodynamic impact of torrefaction on gasification and has missed the fact that the products of devolatilization react in unfavorable ways to form tar with the products of pyrolysis that hurt the yield to syngas.
b) Some products of devolatilization that do not react to form tar can decompose to methane and/or carbon dioxide which are also undesirable and do not result in yield of syngas. Acetic acid (CH₃COOH), a major torrefaction product, can readily decompose to methane and carbon dioxide at typical gasifier temperatures.
c) It is important to control the degree of torrefaction in order to maintain the optimum yield of syngas. That is, it is important to ensure that only volatile species are removed and that the backbone of the biopolymer is left intact.

Further, torrefaction is capable of producing a relatively uniform pretreated biomass from a wide variety of biomass materials. If desired, the severity of the torrefaction process can be altered to produce a torrefied product having substantially the same energy content as that produced from a completely different biomass feedstock. This has advantages in the design of a gasifier feed system and greatly simplifies the gasifier operation with respect to controlling the H₂:CO ratio in the resulting syngas. In addition, by selectively removing the carboxylates in the torrefaction unit, it is believed that less methane will be produced and fewer tars will be formed during gasification by reactions between aldehydes and carboxylic acids formed by the decomposition of hemicellulose and acids and phenols derived from lignin.

Torrefied biomass retains a high percentage of the energy content of the initial biomass feedstock (ca.˜90%). Gaseous products produced during torrefaction are typically comprised of condensable and non-condensable gases. The condensable gases are primarily water, acetic acid, and oxygenates such as furfural, formic acid, methanol, and lactic acid. As previously mentioned, it is preferred that the biomass feedstock be dried prior to torrefaction to facilitate use of the condensable oxygenates as a heating fuel (typically having a heating content greater than 65 BTU/SCF). The non-condensable gases are comprised primarily of carbon dioxide and carbon monoxide, but may also contain small amounts of hydrogen and methane.

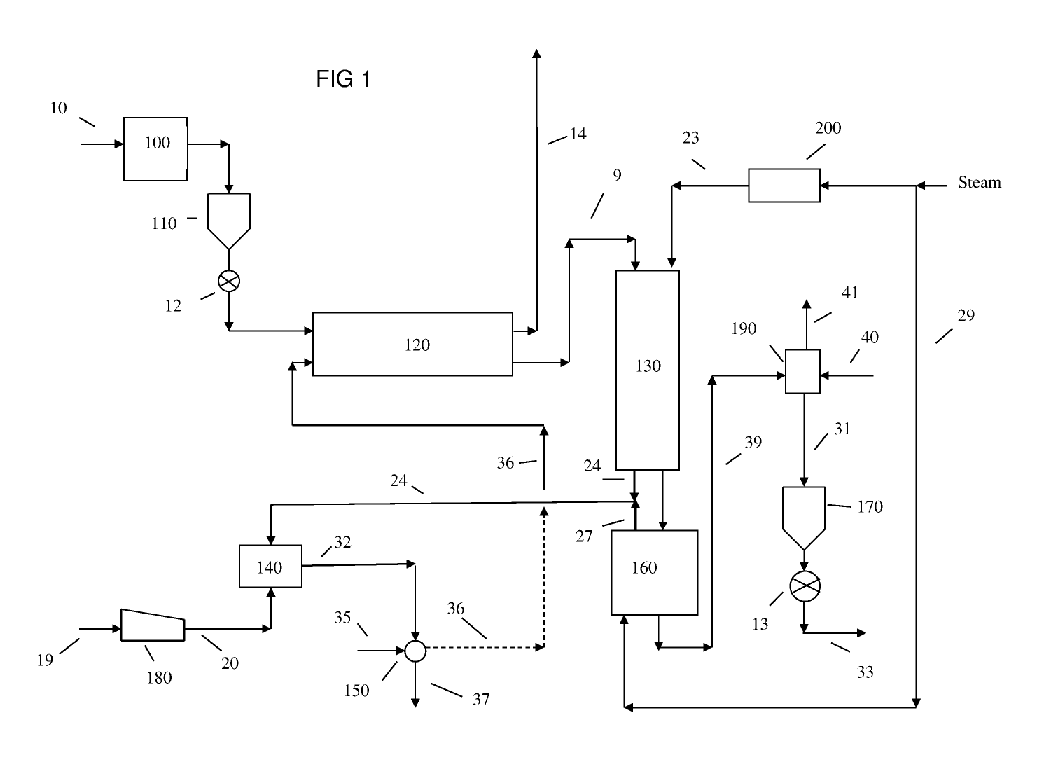

The present invention will be better understood with reference to FIG. 1 hereof. This FIGURE is a simple block diagram representation of a preferred mode for practicing the present invention. A biomass feedstock, preferably a cellulosic biomass, is fed via line 10 to milling zone 100 where it is reduced to an average particle size of about 0.1 to about 3 inches, preferably from about 0.25 to 1.5 inches. The biomass feedstock, now of reduced size, is passed to feed bin 110 where it is held until being passed through first metering device 12 and then to drying zone 120. Drying zone 120 can be operated in an oxidizing or a non-oxidizing atmosphere and at an outlet temperature from about 120° C. to about 175° C. Drying zone 120 is preferably a direct dryer that can be operated in a co-current mode or a counter-current mode. Drying zone 120 will be operated at such conditions to achieve a maximum moisture content of the biomass to about 10 wt %. A water vapor phase from drying zone 120 is exhausted to the atmosphere via line 14.

The resulting dried torrefied biomass solids from drying zone 120 are conducted via line 9 to torrefaction reactor 130 where it combines with a flow of superheated steam via line 23 from superheater 200 that receives a stream of steam from a steam source and increases its temperature to superheated values ranging from about 425° C. to about 510° C., preferably from about 425° C. to about 480° C. The enthalpy of the superheated steam is used to heat the dried biomass up to the desired torrefaction reaction temperature. The steam also is used to inert the reactor atmosphere as well as sweeping the gaseous compounds away from the solids. The Torrefaction reactor 130 is operated in a non-oxidizing atmosphere and at a temperature from about 200° C. to about 350° C., preferably from about 215° to about 320° C., and more preferably at a temperature of about 220° to about 300° C. Any type of torrefaction reactor can be used in the practice of the present invention. Non-limiting example of such types of torrefaction reactors include continuous reactors, non-limiting example that include horizontal moving bed reactors, fluid bed reactors, and jet mill reactors. It is preferred that the reactor be a moving bed reactor. If a fluid bed reactor is used it is preferred that a cyclone be used to separate fines from the resulting product vapor phase that is passed via line 24. The separated fines can be returned to the fluid bed. The resulting tor-gas will typically be comprised of primarily water vapor with additional amounts of methane, methanol, acetol, CO, CO2, furfural, and low carbon organic acids such as formic acid, acetic acid, and lactic acid.

The tor-gas stream 24 is conducted to combustion zone 140 and combined with blown air via line 20 that is produced by passing air via 19 through a blower 180. The blown air and tor-gas are combusted in the combustor 140 at an effective temperature to destroy at least 99% of any volatile organic components of the tor-gas and produce a heated flue gas 32. The heated flue gas 32 is directed to heat exchanger 150 whereby a heat transfer fluid, typically air, 35 is heated, resulting in a cooled flue gas stream 37 and heated heat transfer fluid stream 36, which is used as a drying media in the drier 120.

While torrefaction results in the removal of a significant fraction of volatile species that become part of the tor-gas stream, the majority which is combusted in combustor 140, enough volatiles remain in the torrefied solids to pose a potential safety issue downstream, such as in the case where the torrefied solids undergo densification (pelletization or briquetting) and stored or packaged in large quantities, as opposed to being passed to a gasification process unit. Consequently, it is preferred that the torrefied solids of the present invention be stripped of substantially all of any remaining volatile components. A slip stream of steam is injected via line 29 to help strip any remaining organic volatile moieties from the torrefied solids. The stripped volatiles and other gases, as well as steam, exits stripper 160 via line 27 and is combined with tor-gas exiting reactor 130, via line 24 and passed to combustion zone 140. It will be understood that any suitable equipment can be used to generate steam, which equipment are well known in the art. Although the stripping zone is shown as a separated process unit in the FIGURE hereof it is to be understood that the stripping zone can also be a separate downstream zone internal to the torrefaction reactor.

The torrefied and stripped solids are passed to a heat exchanger 190 via line 39 to cool the material to less than about 150° C. Cooling media enters the heat exchanger via line 40 and exits through line 41. This heat exchanger could also be designed to act as the stripping zone 160. The cooled torrefied biomass proceeds, via line 31 to bin 170 where they are metered via second metering device 13 to be sent downstream via line 33 to storage, densification, or directly to a gasification unit (not shown) for the production of syngas.

It will be understood that a jet mill torrefaction reactor can be used as the torrefaction reactor. If a jet mill torrefaction reactor is used then there will be no need for a milling step prior to gasification since the particle size of the biomass exiting a jet mill reactor will be well within the acceptable particle size for fluid bed gasification.

What is claimed is:

1. a process for preparing a biomass feedstream for gasification, which process comprises:
a) comminuting said biomass to an effective particle size;
b) conducting said comminuted biomass to a drying zone wherein at least about 90 wt. % of water is removed thereby resulting in a dried comminuted biomass stream and a first vapor stream;
c) passing said dried comminuted biomass stream to a torrefaction zone where it is torrefied at temperatures ranging from about 200° C. to about 350° C., in a substantially non-oxidizing environment and at an effective residence time to result in a weight loss of from about 10% to about 15% on a dry ash-free basis, thereby resulting in a second vapor phase stream comprised of water vapor and small amounts of organic components, and a torrefied comminuted biomass solids stream containing small amounts of organic moieties;
d) passing said torrefied comminuted biomass solids stream to a stream stripping zone wherein it is contacted with superheated?? steam wherein at least a portion of said organic moieties is stripped from the torrefied comminuted biomass solids;
e) passing at least a portion of said stripped torrefied dried comminuted biomass stream to a gasification zone;
f) venting at least a portion of said first vapor stream to the atmosphere and conducting at least a portion of any remaining first vapor stream to a combustion zone;
g) conducting at least a portion of said second vapor stream to said combustion zone and recycling at least a portion of any remaining second vapor stream to said torrefaction zone to act as a sweep gas, wherein said combustion zone is operated at an effective time and temperature that will result in the conversion of at least 99 wt. % of any volatile organic components from said second vapor phase to a hot flue gas;
h) conducting a portion of said hot flue gas to said drying zone to provide at least a portion of the heat necessary to dry the biomass to a predetermined level;
i) passing at least a portion of the remaining hot flue gas through a first passageway of a heat exchanger having a first passageway and a second passageway contiguous to each other but not in fluid communication with each other, wherein each of said passageways having an inlet and an outlet and wherein each passageway is constructed to allow a fluid to pass from its inlet to its outlet and to allow heat to be transferred from a fluid of one passageway to a fluid in the other passageway; and
j) passing a heat transfer medium through said second passageway of said heat exchanger wherein heat is transferred from said hot flue gas passing through said first passageway of said heat exchanger thereby resulting in a heated heat transfer medium and a cooled flue gas.

2. The process of claim 1 wherein the biomass is a lignocellulosic material.

3. The process of claim 2 wherein the lignocellulosic biomass is selected from the group consisting of corn, corn stover, corn cobs, alfalfa stems, wheat straw, rice straw, rice hulls, kennaf, distiller's grains, sugar cane bagasse, sugar beet tailings wood wastes, railroad ties, trees, softwood forest thinnings, barky wastes, sawdust, paper, wood fiber, grass crops, grass clippings, tree clippings and the like.

4. The process of claim 3 wherein the lignocellulosic biomass is selected from sugar cane bagasse and sugar beet tailings.

5. The process of claim 1 wherein the temperature of said drying zone is from about 120° C. to about 175° C.

6. The process of claim 1 wherein the temperature of said torrefaction zone is from about 215° C. to about 320° C.

7. The process of claim 1 wherein the temperature of said torrefaction zone is from about 220° C. to about 300° C.

8. The process of claim 1 wherein at least about 98 wt. % of the moisture is removed from the biomass in said drying zone.

9. The process of claim 8 wherein substantially all of the moisture is removed from the biomass in said drying zone.

10. The process of claim 1 wherein the residence time of the biomass in said drying zone is from about 10 to 60 minutes.

11. The process of claim 1 wherein the vessels used in said drying zone and said torrefaction zone are independently selected from the group consisting of moving bed reactors, fluid bed reactors and jet mill reaction vessels.

12. The process of claim 11 wherein the reaction vessels for both said drying zone and said torrefaction zone are moving bed reaction vessels.

13. The process of claim 1 wherein the gasification zone is a fluid bed gasification zone.

14. The process of claim 1 wherein the biomass is comminuted to an average particle size of from about 0.1 to 3 inches.

15. The process of claim 1 wherein the torrefied biomass is reduced to a particle size ranging from about 1 to 500 microns.
